(19) United States
(12) Patent Application Publication
(10) Pub. No.: US 2007/0100109 A1
(43) Pub. Date: May 3, 2007

(54) Nanoporous materials and methods of formation thereof

(76) Inventors: Nigel Hacker, Palo Alto, CA (US); Scott Leffert, Sunnyvale, CA (US); Lisa Figge, Menlo Park, CA (US); Richard Spear, Portland, OR (US); William Bedwell, San Jose, CA (US); Teresa Ramos, Albuquerque, NM (US)

Correspondence Address: BUCHALTER NEMER, 18400 VON KARMAN AVE., SUITE 800, IRVINE, CA, 92612, US

(21) Appl. No.: 10/520,252

(22) PCT Filed: Aug. 15, 2002
(86) PCT No.: PCT/US02/26276

§ 371 Date: Oct. 2, 2006

(51) Int. Cl. C08G 77/12

(52) U.S. Cl. 528/31; 528/43

(57) ABSTRACT

Low dielectric materials are described herein that comprise a plurality of pores or nanopores in addition to the ultrananopores. It is further contemplated that the low dielectric materials described herein will have a dielectric constant of less than about 3. The dielectric materials are fromed from polymer compositions, wherein the polymer compositions comprise a plurality of monomers and wherein at least one monomer comprises a radical precursor bonded to a structural precursor. Further, methods of forming dielectric materials from polymer compositions are presented. The figure shows the chemical structure for a methyl/t-butyl Low organic Content/Low Organic Siloxane Polymer.

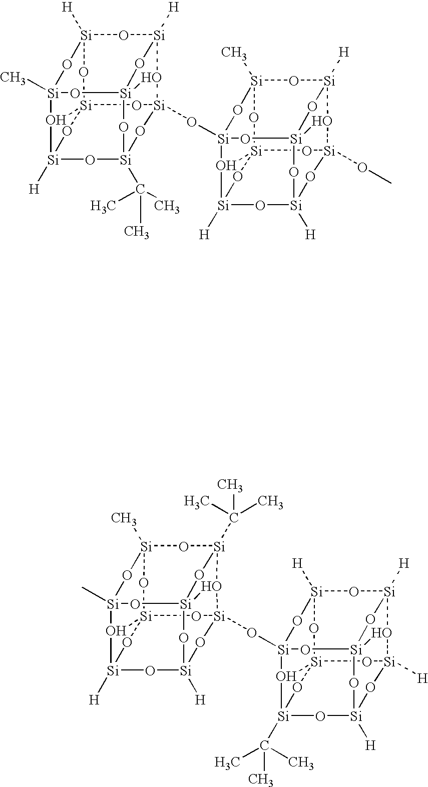

### FIELD OF THE INVENTION

The field of the invention is nanoporous and ultrananoporous materials, layers and components.

### BACKGROUND OF THE INVENTION

As the size of functional elements in integrated circuits decreases, complexity and interconnectivity increases. To accommodate the growing demand of interconnections in modern integrated circuits, on-chip interconnections have been developed. Such interconnections generally consist of multiple layers of metallic conductor lines embedded in a low dielectric constant material. The dielectric constant in such material has a very important influence on the performance of an integrated circuit. Materials having low dielectric constants (i.e., below 2.5) are desirable because they allow faster signal velocity and shorter cycle times. In general, low dielectric constant materials reduce capacitive effects in integrated circuits, which frequently leads to less cross talk between conductor lines, and allows for lower voltages to drive integrated circuits.

Low dielectric constant materials can be characterized as predominantly inorganic or organic. Inorganic oxides, such as silicon oxides or aluminum oxides, often have dielectric constants of 4 and above, which can become problematic when device features in integrated circuits are smaller than 1 μm. Organic polymers include epoxy networks, cyanate ester resins, polyarylene ethers, and polyimides. Epoxy networks frequently show disadvantageously high dielectric constants at about 3.8-4.5. Cyanate ester resins have relatively low dielectric constants between approximately 3.0-3.7, but tend to be rather brittle, thereby limiting their utility. Polyimides and polyarylene ethers have shown many advantageous properties including high thermal stability, ease of processing, low stress, low dielectric constant and high resistance, and such polymers are therefore frequently used as alternative low dielectric constant polymers.

With respect to other properties, desirable dielectrics should also be free frown moisture and out-gassing problems, have suitable adhesive and gap-filling qualities, and have suitable dimensional stability towards thermal cycling, etching, and CMP processes (i.e., chemical, mechanical, polishing). Preferred dielectrics should also have Tg values (glass transition temperatures) of at least 300° C., and preferably 400° C. or more.

The demand for materials having dielectric constant lower than 3 has led to the development of dielectric materials with designed-in nanoporosity. Since air has a dielectric constant of about 1, a major goal is to reduce the dielectric constant of nanoporous materials down towards a theoretical limit of 1. Several approaches are known in the art for fabricating nanoporous materials, including U.S. Pat. No. 5,458,709 issued to Kamezaki and U.S. Pat. No. 5,593,526 issued to Yokouchi. Related and copending applications, Ser. Nos.: 60/128465; 60/128,533; 60/128,534; 60/128,493 and 60/133,218, also address approaches for fabricating nanoporous materials. In these applications, it is disclosed that nanoporous materials can be fabricated a) from polymers having backbones with reactive groups used in crosslinking; b) from polymer strands having backbones that are crosslinked using ring structures; and c) from stable, polymeric template strands having reactive groups that can be used for adding thermolabile groups or for crosslinking; d) by depositing cyclic oligomers on a substrate of the device, including the cyclic oligomers in a polymer, and crosslinking the polymer to form a crosslinked polymer; and e) by using a dissolvable phase to form a polymer.

These methods of creating voids in dielectric materials generally, however, are confined to creating the voids between and within strands of molecules through intermolecular cross-linking or intramolecular cross-linking of the strands of polymers or molecules to create the void or through using large ring structures or macrocycles to create “built-in” voids in the dielectric material. The voids created through the cross-linking processes can lead to the production of relatively large voids in the dielectric material. When larger voids are created in a material, the overall porosity of the material must be carefully monitored and regulated. A single layer material can only realistically sustain a large pore porosity of around 30% of the total material before structural problems are encountered. NANOGLAS S®E is an example of a material that comprises about 50% porosity. Single layer materials that have a large pore porosity significantly over 30% tend to be weak and can in some cases collapse. Collapse can be prevented to some degree by adding crosslinking additives to the starting material that couple thermostable portions with other thermostable portions, thereby producing a more rigid single-layer dielectric network. However, the porous material, even after cross-linking, can lose mechanical strength as the porosity increases, and the material will be unable to survive during integration of the dielectric film to a circuit. Also, the porous material, even after cross-linking, can lose mechanical strength by not having external support by additional coupled nanoporous layers.

Therefore, there is a need to provide methods and compositions a) to produce dielectric materials comprising various nanoporous low dielectric materials that can combine porosity with thermal and structural durability, b) to design in a pre-determined blend of large pores and relatively small pores, and c) to produce dielectrics with ultra small pores. There is also a need to increase the overall porosity of a dielectric material beyond the percent porosity constraints of conventional dielectrics. Further, there is a need to use these novel dielectric materials to produce dielectric films, layered dielectric materials, layers, etchstops, hardmasks and other electronic components.

### SUMMARY OF THE INVENTION

The present invention is generally directed to low dielectric materials, films, layers, layered components and other related electronic materials and components that comprise a plurality of ultrananopores. The dielectric materials contemplated herein may also comprise a plurality of pores or nanopores in addition to the ultrananopores. It is further contemplated that the low dielectric materials described herein will have a di electric constant of less than about 3.

In one aspect of the present invention, the dielectric materials are formed from polymer compositions, wherein the polymer compositions comprise a plurality of monomers ad wherein at least one monomer comprises a radical precursor chemically bonded to a structural precursor. These polymer compositions may undergo several curing stages during the formation and buildup process, but after the final polymer curing stage, the resulting nanoporous polymer material will comprise a support material and a plurality of ultrananopores. The support material is ultimately formed from the structural precursor that helps to make up the original pre-cured polymer composition. The ultrananopores are ultimately formed from the volatilization and simultaneous and/or subsequent liberation of the radical precursor that is chemically bonded to the structural precursor.

In another aspect of the present invention, methods of forming dielectric materials from polymer compositions are presented. Low dielectric materials comprising the polymer compositions described herein can be formed by a) providing a polymer composition, wherein the polymer composition comprises at least one polymer component that further comprises at least one monomer component and wherein the at least one monomer component comprises a radical precursor chemically bonded to a structural precursor; b) applying energy to the polymer composition, such that the radical precursor is volatilized; and c) liberating/evolving at least in part the radical precursor from the polymer composition. The low dielectric materials can be further formed by curing the polymer composition to form a support material and a plurality of pores.

In yet another aspect of the present invention, contemplated polymer compositions can be used to form low dielectric materials, layered dielectric materials, low dielectric films, etchstops and hardmasks, air gaps, semiconductor components and electronic components.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows IR data for a standard LOSP compound.

FIG. 2 shows IR data for an n-butyl LOSP compound.

FIG. 3 shows IR data for a t-butyl LOSP compound.

FIG. 4A shows the chemical structure of a standard LOSP compound.

FIG. 4B shows the chemical structure for a methyl/t-butyl LOSP compound.

FIG. 5 shows the GPC profile of a standard LOSP compound.

FIG. 6 shows the GPC profile of a 10/10 LOSP compound.

FIG. 7 shows the GPC profile of a 5/15 LOSP compound.

FIG. 8 shows IR data for balked LOSP films.

FIG. 9 shows IR data for cured LOSP films.

### DETAILED DESCRIPTION

Polymer compositions, as described herein, comprise at least one polymer component that further comprises at least one monomer component and wherein the at least one monomer component comprises a radical precursor chemically bonded to a structural precursor. These polymer compositions may undergo several curing stages during the formation and buildup process, but after the final polymer curing stage, the resulting nanoporous polymer material will comprise a support material and a plurality of ultrananopores. The support material is ultimately formed from the structural precursor that helps to make up the original pre-cured polymer composition. The ultrananopores are ultimately formed from the volatilization and simultaneous and/or subsequent liberation/evolution of the radical precursor that is chemically bonded to the structural precursor. Contemplated polymer compositions can be used to form low dielectric materials, dielectric films, layered dielectric materials, layered dielectric films, electronic components and combinations thereof.

Dielectric materials, which are also known as insulator materials, having low dielectric constants (i.e., below 3) are especially desirable; because they typically allow faster signal propagation, reduce capacitive effects and cross talk between conductor lines, and lower voltages to drive integrated circuits. The phrase “dielectric constant” means a dielectric constant evaluated at 1 MHz to 2 GHz, unless otherwise inconsistent with context. It is contemplated that the value of the dielectric constant of the nanoporous polymer be low, which is considered in the art to be less than about 3. In a preferred embodiment, the value of the dielectric constant is less than about 2.5, and in still more preferred embodiments, the value of the dielectric constant is less than about 2.

Unless otherwise indicated, all numbers expressing quantities of ingredients, constituents, reaction conditions and so forth used in the specification and claims are to be understood as being modified in all instances by the term “about”. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

As used herein, the phrases “nanoporous layer” and “nanoporous materials” refer to any suitable low dielectric material (i.e. ≦3) that is composed of a plurality of voids and a non-volatile, support material or structural component. As used herein, the term “substantially” when used in a context describing the amount of a component in a total product means that a desired component is present in a product or layer at a weight percent a mount greater than 51%.

As used herein, the terms “void” and “pore” mean a free volume in which a mass is replaced with a gas or where a vacuum is generated. The composition of the gas is generally not critical, and appropriate gases include relatively pure gases and mixtures thereof, including air. It is intended that the terms pore and void can be used interchangeably herein. The nanoporous polymer may comprise a plurality of voids. Voids are typically spherical, but may alternatively or additionally have any suitable shape, including tubular, lamellar, discoidal, or other shapes. The voids may be uniformly or randomly dispersed within the nanoporous polymer. In a preferred embodiment, the voids are uniformly dispersed within the nanoporous polymer. It is also contemplated that the voids may have any appropriate diameter. It is further contemplated that at least some voids may connect with adjacent voids to create a structure with a significant amount of connected or “open” porosity. Some of the voids will have a mean diameter of less than 1 micrometer, and more preferably have a mean diameter of lass than about 100 nanometers, because the voids are formed between polymer strands. It is intended, however, that “ultrananopores” will also and preferably form in the polymer composition that have a mean diameter of less than about 10 nanometers. Further, it is contemplated that these ultrananopores may have a mean diameter that is on the order of a few Angstroms, because of the volatilization and at least partial liberation of the radical precursor.

The polymer composition can take on a any suitable form, including liquid, solid, amorphous or crosslinked, depending on the specific application. For example, the application may call for the polymer composition to be spun on to a wafer before curing; and therefore, the polymer composition needs to be a) dissolvable in a solvent, b) able to form a smooth coating on a wafer during the spin-on process and after being spun-on to the wafer and c) able to be reliably cured to a nanoporous polymer material in a manufacturing setting. For other applications, it may be necessary for the polymer composition to be rigid before final curing, which means that the polymer composition will need to be a) close to or completely solid, b) able to withstand mechanical or chemical etching or tools, and c) possibly cross-linked before final curing.

The term “crosslinking” refers to a process in which at least two molecules, or two portions of a long molecule, are joined together by a chemical interaction. Such interactions may occur in many different ways, including formation of a covalent bond, formation of hydrogen bonds, hydrophobic, hydrophilic, ionic or electrostatic interaction. Furthermore, molecular interaction may also be characterized by an at least temporary physical connection between a molecule and itself or between two or more molecules.

As mentioned earlier, the polymer composition comprises at least one polymer component that further comprises at least one monomer component and wherein the at least one monomer component comprises a radical precursor chemically bonded to a structural precursor. As used herein, the term “monomer” generally refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. The weight-average molecular weight of monomers may vary greatly between about 40 Dalton and 20000 Dalton. However, especially when monomers comprise repetitive building blocks, monomers may have even higher molecular weights. Monomers may also include additional groups, such as groups used for crosslinking, radiolabeling, and/or chemical or environmental protecting.

As also mentioned, at least one of the monomers comprises a structural precursor and a radical precursor. It is generally intended that the structural precursor and radical precursor combine through a conventional-type of chemical bond, such as an ionic bond or a covalent bond, to make one molecule that further makes up the monomer, however, the structural precursor and the radical precursor could be chemically or physically bonded also by hydrogen bonding, hydrophobic, hydrophilic, ionic or electrostatic interaction. Furthermore, structural precursor and radical precursor combination may also be characterized by an at least temporary physical connection between the two precursors.

The structural precursor is that portion of the monomer that remains as part of the ultrananoporous polymer (low dielectric material) and ultimately forms the support material after the final curing stage for the polymer composition. The structural precursor can be chosen to satisfy specific design goals for the polymer composition, the final cured ultrananoporous polymer (low dielectric material) or both. Given the spectrum of possible design goals ranging from structural durability to readily available and cost-efficient materials, it is contemplated that the structural precursor can comprise organic compounds, inorganic compounds, organometallic compounds or a combination of organic, inorganic or organometallic moieties. Examples of contemplated inorganic and organometallic compounds are silicates, siloxanes, organohydridosiloxanes, hydridosiloxanes, aluminates, poly(dimethylsiloxane), poly(vinylsiloxane) and poly(trifluoropropylsiloxane) and compounds containing transition metals. Examples of organic compounds include poly(arylene ether), polyimides, polyesters, and cage-based materials, such as adamantane-based or diamantine-based compounds.

Organohydridosiloxane-based components and compounds are particularly suitable for forming materials comprising ultrananopores and for forming caged siloxane polymer films that are useful in the fabrication of a variety of electronic devices, micro-electronic devices, particularly semiconductor integrated circuits and various layered materials for electronic and semiconductor components, including hardmask layers, dielectric layers, etch stop layers and buried etch stop layers. These organohydridosiloxane compounds, layers and materials are quite compatible with other materials that might be used for layered materials and devices, such as adamantane-based compounds, diamantane-based compounds, silicon-core compounds, organic dielectrics, and nanoporous dielectrics. Compounds that are considerably compatible with the organohydridosiloxane compounds, layers and materials contemplated herein are disclosed in PCT Application (PCT/US01/32569); U.S. application Ser. No. 09/538,276; U.S. application Ser. No. 09/544,504; U.S. application Ser. No. 09/587,851; U.S. Pat. No. 6,214,746; U.S. Pat. No. 6,171,687; U.S. Pat. No. 6,172,128; and U.S. Pat. No. 6,156,812, which are all incorporated herein by reference in their entirety.

Organohydridosiloxane compounds and materials utilized herein in some of the embodiments of the present invention have the following general formulas:
[H—Si_{1.5}]ₙ[R—SiO_{1.5}]ₘ Formula (1)
[H_{0.5}—Si_{1.5-1.8}]ₙ[R_{0.1-1.0}—SiO_{1.5-1.8}]ₘ Formula (2)
[H_{0-1.0}—Si_{1.5}]ₙ[R—SiO_{1.5}]ₘ Formula (3)
[H—Si_{1.5}]ₓ[R—SiO_{1.5}]_{y}[SiO₂]_{z} Formula (4)
wherein:
the sum of n and m, or the sum or x, y and z is from about 8 to about 5000, and m or y is selected such that carbon containing constituents are present in either an amount of less than about 40 percent (Low Organic Content/Low Organic Siloxane Polymer=LOSP) or in an amount greater than about 40 percent (High Organic Content/High Organic Siloxane Polymer=HOSP); R is selected from substituted and unsubstituted, normal and branched alkyls (methyl, ethyl, butyl, propyl, pentyl), alkenyl groups (vinyl, allyl, isopropenyl), cycloalkyls, cycloalkenyl groups, aryls (phenyl groups, benzyl groups, naphthalenyl groups, anthracenyl groups and phenanthrenyl groups), and mixtures thereof; and wherein the specific mole percent of carbon containing substituents is a function of the ratio of the amounts of starting materials. In some LOSP embodiments, particularly favorable results are obtained with the mole percent of carbon containing substituents being in the range of between about 15 mole percent to about 25 mole percent. In some HOSP embodiments, favorable results are obtained with the mole percent of carbon containing substituents are in the range of between about 55 mole percent to about 75 mole percent.

A synthesis of the organohydridosiloxane composition includes a dual phase solvent system using a catalyst. In some embodiments of the present invention, the starting materials encompass trichlorosilane and an organotrichlorosilane, for example either an alkyl alkenyl, or an aryl substituted trichlorosilane. The relative ratios of the trichlorosilane and the organotrichlorosilane determine the mole percent carbon-containing substituents in the polymer.

In some embodiments, the method of this invention includes:
1) mixing a solution of hydridotrihalosilanes and organic-substituted trihalosilanes (e.g. trichlorosilane and alkyl, alkenyl or aryltrichlorosilane) to provide a mixture,
2) combining the mixture with a dual phase solvent including a non-polar solvent, and a polar solvent to provide a dual phase reaction mixture,
3) adding a solid phase catalyst to the silane/solvent reaction mixture,
4) reacting the silanes to produce organohydridosiloxanes, and
5) recovering the organohydridosiloxane from the organic portion of the dual phase solvent system.

Additional steps may include washing the recovered organohydridosiloxane to remove any unreacted monomer, and fractionating the organohydridosiloxane product to thereby classify the product according to molecular weight.

In other embodiments, the catalyst is a phase transfer catalyst including, but not limited to, tetrabutylammonium chloride, and benzyltrimethylammonium chloride. The phase transfer catalyst is introduced into the reaction mixture and the reaction is allowed to proceed to the desired degree of polymerization.

In accordance with one aspect of the method of this invention, a dual phase solvent system includes a continuous phase non-polar solvent and a polar solvent. The non-polar solvent includes, but is not limited to, any suitable alkyl, alkenyl or aryl compounds or a mixture of any or all such suitable compounds, the operational definition of “suitable” in the present context includes the functional characteristics of:
1) solubilizing the monomeric silicon compounds,
2) solubilizing the polymer product,
3) stability of the polymer product in the solvent, and
4) insolubility of unwanted reaction products.

Contemplated solvents include any suitable pure or mixture of organic, organometallic or inorganic molecules that are volatilized at a desired temperature, such as the critical temperature. The solvent may also comprise any suitable pure or mixture of polar and non-polar compounds. In preferred embodiments, the solvent comprises water, ethanol, propanol, acetone, ethylene oxide, benzene, toluene, ethers, cyclohexanone, butryolactone, methylethylketone, and anisole. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound. Particularly preferred solvents include, but are not limited to, pentane, hexane, heptane, cyclohexane, benzene, toluene, xylene, halogenated solvents such as carbon tetrachloride, and mixtures thereof.

The second solvent phase is a polar phase, immiscible with the organic, non-polar solvent phase, and includes water, alcohols, and alcohol and water mixtures. It is thought that alcohol solubilizes reactive intermediates that are not yet soluble in the non-polar phase and would ordinarily be unstable in a substantially aqueous phase. The amount of alcohol present is, however, not so high as to significantly dissolve product polymers having molecular weights greater than about 400 AMUs.

Alcohols and other polar solvents suitable for use in the polar phase include, but are not limited to, water, methanol, ethanol, isopropanol, glycerol, diethyl ether, tetrahydrofuran, diglyme and mixtures thereof. In one embodiment, the polar solvent includes a water/alcohol mixture wherein the water is present in an amount sufficient to preferentially solubilize ionic impurities not soluble in alcohol, and/or preclude solvent extraction of product compounds that might otherwise be soluble in alcohol. The polar solvent phase advantageously retains the hydrochloric acid (HCl) condensation product and any metal salt or other ionic contaminants that may be present. Since any ionic contaminants are retained in the polar solvent phase, the organohydridosiloxane product of this invention is of high purity and contains essentially no metal contaminants.

In another embodiment of the method disclosed herein, a solid phase catalyst and/or ion exchange resin, such as the Amberjet 4200 or Amberlite I-6766 ion exchange resins (both available from Rohm and Hass Company, Philadelphia, Pa.), surface catalyzes the polymerization of the trihalosilane and organo-trihalosilane monomers into the composition of this invention. Amberjet 4200 is a basic anion exchange resin based on the chloride ion. Amberlite I-6766 is also a basic anion exchange resin. By way of explanation, and not by way of limitation, it is thought polymer chain propagation occurs on the catalyst surface by hydrolysis of the Si—Cl bond of the monomer to Si—OH, followed by condensation with another Si—OH to provide an Si—O—Si bond, thereby extending the polymer chain. In other embodiments, polymerization is catalyzed with a phase transfer catalyst such as tetrabutylammonium chloride.

In other embodiments of the present invention, the amount of organotrichlorosilane monomer present is an amount sufficient to provide an as-cured layer or film having an organic content of less than about 40 mole percent carbon containing substituents for the LOSP applications and an organic content of greater than about 40 mole percent carbon-containing substituents for the HOSP application. These films provide low dielectric constants, typically less than 3.0. In some embodiments, particularly organohydridosiloxane embodiments, the carbon-containing substituent content is a function of the mole percent alkyl-, alkenyl- or aryltrihalosilane.

Other useful organosiloxanes are disclosed in commonly assigned U.S. patent application Ser. Nos. 09/420,218 filed Oct. 18, 1999 and one filed on Jun. 2, 2002 where the serial number has yet to be assigned.

Preferred polymers, monomers, polymer and monomer solutions are designed and contemplated to be spin coated, rolled, dripped, sprayed, or vaporized and deposited onto a wafer, a substrate or layered material. Most preferred solutions are designed to be spin coated or vaporized and deposited onto a wafer, a substrate or layered material. Substrates contemplated herein may comprise any desirable substantially solid material. Particularly desirable substrate layers would comprise films, glass, ceramic, plastic, metal or coated metal, or composite material. In preferred embodiments, the substrate comprises a silicon or germanium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. The “substrate” may even be defined as another polymer chain when considering cohesive interfaces. In more preferred embodiments, the substrate comprises a material common in the packaging and circuit board industries such as silicon, copper, glass, and another polymer.

Electronic components, as contemplated herein, are generally thought to comprise any dielectric component or layered dielectric component that can be utilized in an electronic-based product. Contemplated electronic components comprise circuit boards, chip packaging, dielectric components of circuit boards, printed-wiring boards, and other components of circuit boards, such as capacitors, inductors, and resistors.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up mock-up. A prototype may or may not contain all of the actual components intended in a finished product, and a prototype may have some components that are constructed out of composite material in order to negate their initial effects on other components while being initially tested. Electronic products and components may comprise layered materials, layered components, and components that are laminated in preparation for use in the component or product.

The polymer compounds and compositions used in making the dielectric films, layers, materials, components, hardmasks and etch stop layers contemplated herein can have molecular weights between about 400 and 200,000 atomic mass units. All molecular weights are reported as weight average molecular weights. Preferably, the polymers have molecular weights between about 5000 and 60,000 atomic mass units, more preferably between about 140,000 and 50,000 atomic mass units, and most preferably between about 20,000 and 40,000 atomic mass units.

The radical precursor is that portion of a monomer that is volatilized and is at least in part liberated from the structural precursor and/or the support material in order to form the ultrananopores or ultrananovoids in the resulting ultrananoporous polymer material. The radical precursor comprises any chemical material that can be separated from the structural precursor and volatilized at temperatures that will not detrimentally break down, deteriorate or otherwise volatilize the remaining chemical backbone of the structural precursor or subsequently formed support material. In other words, the radical precursor comprises any chemical material or compound that can separate away from the structural precursor during the cure stage and volatilize to form a pore or void in the polymer composition, thus forming the ultrananoporous material. It could be desirable to crosslink the structural precursor or support material during the temperature program that volatilizes the radical precursor, but the crosslinking in this instance is a planned design step and is not detrimental to the final product. Contemplated radical precursors are hydrocarbon compounds, such as alkyl-based or alkynyl-based compounds. It is further contemplated that aromatic molecules, cyclic molecules and cage-based molecules can comprise the radical precursor, as long as the radical precursor is capable of separating away from the structural precursor and volatilizing to form the ultrananovoid or ultrananopore. Preferred radical precursors are alkyl groups, such as ethyl groups, butyl groups, pentyl groups and hexyl groups.

Given the previous discussion of monomers and contemplated monomers, it is important to note that a given polymer composition does not have to completely comprise monomers having a structural precursor and a radical precursor. A contemplated polymer composition may need to be designed to comprise nanopores and ultrananopores. In this instance, several of the components of the polymer composition may be designed to form nanopores by methods described and incorporated herein, including cross-linking, cage-based molecules, wherein the cage center forms the “pore” and macrocycles. Several of the components of the same polymer composition may also be designed to form the ultrananopores discussed herein by incorporating monomers comprised of structural precursors and radical precursors.

A given polymer composition may also comprise other polymers formed by conventional means or not designed to produce a porous, nanoporous or ultrananoporous environment. Reasons why other polymers may be incorporated into a polymer composition could be a) to provide additional backbones for crosslinking or stability purposes, b) to meet certain design goals of the final product, or c) to provide an optical component to the final product. Contemplated additional polymers may comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The weight average molecular weight of contemplated polymers spans a wide range, typically between 400 Dalton and 400000 Dalton or more.

The organic and inorganic materials described herein are similar in some respects to that which is described in U.S. Pat. No. 5,874,516 to Burgoyne et al. (February 1999), incorporated herein by reference, and may be used in substantially the same manner as set forth in that patent. For example, it is contemplated that the organic and inorganic materials described herein may be employed in fabricating electronic chips, chips, and multichip modules, interlayer dielectrics, protective coatings, and as a substrate in circuit boards or printed wiring boards. Moreover, films or coatings of the organic and inorganic materials described herein can be formed by solution techniques such as spraying, spin coating or casting, with spin coating being preferred. Preferred solvents are 2-ethoxyethyl ether, cyclohexanone, cyclopentanone, toluene, xylene, chlorobenzene, N-methylpyrrolidinone, N,N-dimethylformamide, N,N-dimethylacetamide, methyl isobutyl ketone, 2-methoxyethyl ether, 5-methyl-2-hexanone, γ-butyrolactone, PGMEA, PACE, butylacetate and mixtures thereof. Typically, the coating thickness is between about 0.1 to about 15 microns. As a dielectric interlayer, the film thickness is typically less than 2 microns. Additives can also be used to enhance or impart particular target properties, as is conventionally known in the polymer art, including stabilizers, flame retardants, pigments, plasticizers, surfactants, and the like. Compatible or non-compatible polymers can be blended in to give a desired property. Adhesion promoters can also be used. Such promoters are typified by hexamethyldisilazane, which can be used to interact with available hydroxyl functionality that may be present on a surface, such as silicon dioxide, that was exposed to moisture or humidity. Polymers for microelectronic applications desirably contain low levels (generally less than 1 ppm, preferably less than 10 ppb) of ionic impurities, particularly for dielectric interlayers.

Low dielectric materials comprising the polymer compositions described herein can be formed by a) providing a polymer composition, wherein the polymer composition comprises at least one polymer component that further comprises at least one monomer component and wherein the at least one monomer component comprises a radical precursor chemically bonded to a structural precursor; b) applying energy to the polymer composition, such that the radical precursor is volatilized; and c) liberating/evolving, at least in part, the volatilized radical precursor from the polymer composition. The low dielectric materials can be further formed by curing the polymer composition to form a support material and a plurality of pores.

The polymer composition can be provided by either acquiring the components for the polymer composition from a chemical supply company or a suitable chemical supply source, such as a university. The polymer composition can also be fully synthesized and produced from basic chemical components found at the production site for the dielectric materials and components.

The radical precursor can be volatilized and at least partially removed, evolved or liberated from the structural precursor and subsequently formed support material by any suitable energy source, including a heat source, such as an oven, a microwave generator, actinic light (UV and visible, etc), are electron beam source, a laser source, or an infrared device; a chemical source, such as a catalyst; an acoustic wave source and/or a pressure source. In preferred embodiments, the radical precursor can be volatilized and at least partially removed or liberated by heating the structural precursor or support material. In more preferred embodiments, the radical precursor is volatilized and at least partially removed or liberated/evolved by heating the structural precursor or support material in a gaseous environment at atmospheric pressure. In other preferred embodiments, the radical precursor is volatilized and at least partially removed or liberated/evolved by heating the structural precursor or support material in a gaseous environment at sub-atmospheric pressure. As used herein, the phrase “sub-atmospheric pressure” means that pressure that has a value lower than 760 atmosphere s. As used herein, the phrase “atmospheric pressure” means that pressure that has a value of 760 atmospheres. As used herein, the phrase “gaseous environment” means that environment that contains pure gases, including nitrogen, helium, or argon; or mixed gases, including air.

In addition to furnace or hot plate curing, the present compositions may also be cured by exposure to ultraviolet radiation, microwave radiation, or electron beam radiation as taught by commonly assigned patent publication PCT/US96/08678 and U.S. Pat. Nos. 6,042,994; 6,080,526; 6,177,143; and 6,235,353, which are incorporated herein by reference in their entirety.

The radical precursor should be volatilized and liberated/evolved at least in part during and after the application of an energy source. It is desirable that the radical precursor will be completely volatilized and almost entirely liberated to form the pores, however, it is practically understood that because of dielectric material and layer thickness and general chemical constraints that all of the radical precursor may not be volatilized and/or liberated from the structural precursor and/or the support material.

The structural precursor or support material can be cured to its final form before or after all of the radical precursor is removed from the polymer composition. Although in preferred embodiments the structural precursor or support material is cured using heat, many other methods are contemplated, including catalyzed and uncatalyzed methods. Catalyzed methods may include general acid- and base catalysis, radical catalysis, cationic- and anionic catalysis, and photocatalysis. For example, a dielectric material or dielectric layer may be formed by UV-irradiation, addition of radical starters, such as ammoniumpersulfate, and addition of acid or base. Uncatalyzed methods include application of pressure, or application of heat at subatmospheric, atmospheric or super-atmospheric pressure.

Generally, in one example, a solution of polymer composition is prepared by combining the polymer with an appropriate solvent. Typically, such polymer solutions are approximately 0.02% to 35% (by weight) polymer solids. For example, HOSP BEST comprises 0.55% wt. percent in solution. Advantageously, methyl isobutyl ketone (MIBK), heptane, dodecane, butyl ether, butyl acetate, isobutyl acetate, propyl acetate or a blend of hexamethyldisiloxane, octamethyltrisiloxane, and octamethylcyclotetrasiloxane, or combinations thereof are useful as solvents, although other appropriate solvents may also be employed, including those mentioned earlier. Prior to use, the solvents are preferably dried over 3 Å or 4 Å molecular sieves.

The resulting polymer composition solution, in this general example, is then filtered under ambient conditions via any of the filtration devices well known in the art. It is generally preferable to use a filtration device having a pore size less than about 1 μm. A typical filtration process uses a pore size of about 0.04 μm, however, it is contemplated that the pore size may be smaller than about 0.04 μm.

In the spin coating process, the polymer composition solution prepared in the manner described above is dispensed onto a wafer at or near its center. In some embodiments, the wafer will remain stationary during the dispense cycle, while in some embodiments, the wafer will turn or spin at a relatively low speed, typically less than about 500 revolutions per minute (rpm). The dispense cycle is followed by a short rest period and then additional spins, hereinafter referred to as thickness spins, generally between approximately 2000 and 3000 rpm, although other spin speeds may be used, as appropriate.

Once the coating process, as described above, is completed, the coated substrate, that is the substrate coated with the polymer composition solution, is heated to effect a bake process and a subsequent cure process. The bake process removes the solvent from the polymer composition solution on the substrate, causes the polymer to flow, begins the process of volatilizing the radical precursors, and begins the conversion of the coating to the dielectric film. The cure process completes the conversion of the coating to the film, dielectric film, hardmask, etch stop or other electronic, semiconductor, or layered material application. Any conventional apparatus known in the art can be employed for these processes.

Preferably, the apparatus for the bake process is an integral part of a spin coating apparatus used for coating the substrate or wafer, although a separate apparatus for curing coatings applied is also suitable. The bake process can be carried out in an inert atmosphere such as an atmosphere of an inert gas, nitrogen, or nitrogen/air mixture. One commonly employed heating apparatus employs one or more “hot plates” to heat the coated wafer from below. The coated wafer is typically heated for up to about 120 sec at each of several hot plates at successively higher temperatures. Typically, the hot plates are at temperatures between about 70° C. and 350° C. One typical process employs a heating apparatus having three hot plates. First, the wafer is baked for about 60 sec at 150° C. Then, the wafer is transferred to a second hot plate for an approximately 60 sec bake period at 200° C. Finally, the wafer is transferred to a third hot plate for a third bake period of approximately 60 sec at 350° C.

A final cure process is preferably employed to complete the curing of the film. The cure is preferably performed in an inert atmosphere, as described above fox the bake process. This final cure process can employ a conventional thermal curing apparatus, for example a horizontal furnace with a temperature range of about 300° C. to about 450° C. and preferably from about 375° C. to about 425° C. In a typical furnace cure process, the baked wafer is cured for 30 minutes to one hour at 400° C. at a nitrogen flow rate of 4 liters/min to 20 liters/min.

Alternatively, the cure process can employ a high-temperature hot plate curing module that has an oxygen-density-controlled environment. In this process, the baked wafer is cured on a hot plate at a temperature between about 400° C. and 450° C. for a period of from about 1 to about 15 minutes in a nitrogen or inert atmosphere with an oxygen density of less than about 100 parts per million. For example, a suitable cure atmosphere is achieved with a nitrogen flow rate of between about 10 and about 30 liters/min. Energy sources may also include actinic light (UV and visible sources, etc); an electron beam source and as mentioned, hot plate curing. Also, it is further contemplated that any of the herein mentioned energy sources that are used for curing and volatilizing may be used interchangeably.

It will be understood that the above bake and cure processes were described for illustrative purposes only and that other temperatures, durations, and number of bake cycles can be employed, where appropriate.

The thickness of the resulting dielectric film, layer or material on a substrate depends on a number of variables. The variables include, organic content of the polymer composition, type of substituent in the composition, solvent properties, polymer molecular weight, percentage of the polymer solids in the polymer composition solution, the amount of polymer composition solution dispensed onto the substrate, and the speed of the thickness spin. The higher the percentage of polymer solids in the solution, the thicker the resulting dielectric film. Conversely, the higher the speed of the thickness spin, the thinner the resulting dielectric film. In addition, the thickness of the dielectric film can depend on the nature and amount of the organic constituents in the polymer composition.

According to some embodiments of the present invention, dispensing 2 ml of polymer composition solution that is between about 0.02% and about 35% polymer by weight on a 4 inch wafer, using a spin speed between about 2000 and about 3000 rpm, results in dielectric films ranging from about 1000 Å to about 9000 Å in thickness. It is contemplated herein that the wafer size may include any suitable size wafer, including wafers up to about 12 inches in diameter and above. Variation in thickness, determined by independent measurements on a single wafer, ranges from about 0.4% to 3.2% and preferably the variation in thickness is less than 1%.

In certain embodiments of the present invention, films and layers formed from polymer composition solutions by spin coating methods are provided. The films and layers are formed from solutions of polymer compositions having a mole percent of organic substituents preferably in the range between about 0.1 Mol % and 40 Mol % for LOSP applications and 40 Mol % and about 80 Mol % for HOSP applications. As demonstrated in the examples below, such films advantageously exhibit low dielectric constants, typically approximately 2.8 or lower. Additionally, dielectric films, hardmask layers, etch stop layers, and other layers formed for use in electronic or semiconductor applications exhibit thermal stability permitting cure temperatures up to about 450° C.

The present polymers, monomers and solutions may be used in an all spin-on stacked films as taught by Michael E. Thomas, “Spin-On Stacked Films for Low k_{eff} Dielectrics”, Solid State Technology (July 2001), incorporated herein in its entirety by reference.

### EXPERIMENTAL METHODS

The following characteristics encompass non-limiting measurements that illustrate the properties of the polymer composition, low dielectric materials, layers and films of the present invention. The methods used in measuring the various characteristics of the polymer composition, low dielectric materials, layers and films are as follows:
1) Film Thickness (A): Film thickness is measured using a calibrated Nanospec-RTM. AFT-Y CTS-102 model 010-180 Film Thickness Measurement System available from Nanometrics, Co. An average of measurements at five locations on a wafer are reported as the film thickness for each sample. Thickness measurements are corrected for the refractive index as measured on a Rudolph ellipsometer.
2) Refractive Index: Refractive index is measured on a Rudolph Research AutoEL ellipsometer using a wavelength of 633.3 nm.
3) Dielectric Constant: Dielectric constant is determined using the capacitance-voltage (“CV”) measurement technique and employs a Hewlett-Packard Model 4061A semiconductor measurement system at a frequency of 1 MHz. This test procedure employs a metal-insulator-metal (Mow structure with the thickness of each layer ranging from about 0.5 to 1 micron (μm).
4) Solution Viscosity (cP): A Brookfield Synchro-lectric Viscometer, Model LVT 62238 is employed to measure the viscosity of organohydridosiloxane resin solutions at ambient temperature.
5) Adhesion to Surfaces: The wafer is coated using appropriate spin, Sake, and cure cycles. Studs, kept refrigerated until just before use are glued to the center of at least 15 to 25 samples per wafer made by cleaving the wafer into 2.25 cm² samples. The studs samples with a small vice/clip device (the tool and method are self-explanatory), and the samples are then baked at 150° C. for 60 minutes to cure the epoxy and then cooled to ambient temperature; A Sebastian-5A stud-pull instrument manufactured by The Quad Group, Spokane, Wash., is used to measure the adhesion strength of the polymer film. The tail of the stud is inserted into a receiving cavity in the instrument and automatically pilled upon until the system senses a break. The value recorded is expressed in kpsi (thousand pounds per square inch).
6) Molecular Weight (“MW”): Molecular weight is determined using a gel phase chromatography system from Waters Corporation, Milford, Mass., equipped with a Waters 510 pump, Waters 410 differential refractometer and a Waters 717 autosampler. The procedure used is as set forth by S. Rosen in “Fundamental Principles of Polymeric Materials, pages 53-81, (2nd Ed. 1993) and incorporated herein by reference.
7) Isothermal TGA: Cured films are carefully removed from the wafers, heated to 100° C. and held for one hour to equilibrate before recording initial weight. The instrument is then ramped from 100° C. to 425° C. at 25° C. per minute (under nitrogen atmosphere) and held at 425° C. for four hours to determine percent weight loss.
8) Planarization: Polymer films are spun on silicon wafers patterned with line and space patterns of varying widths (0.35-3.0 μm). The wafers are baked and cured using the appropriate recipe. The cured wafers are then cleaved horizontally across the pattern of lines and this cross-section is examined using a scanning electron microscope (SEM). The degree of planarization for a particular line and space width is calculated by measuring the ratio of the highest point of the film versus the lowest point.
9) Stress: Film stress is measured using a Flexus™ model 2410 Film Stress Measurement System available from Tencor Instruments using standard methods.
10) Crack Threshold: A single coat film is spun, baked, and cured on a bare silicon wafer using the appropriate recipe in 1000 Å thickness increments. The wafers are examined 24-48 hrs following cure to check for cracking.
11) MTM TDMS and GCP Elastomeric techniques are also used in order to determine polymer characteristics.

### METHOD OF MAKING EXAMPLES

The method of making some of the compositions of the present invention include, generally, adding a mixture of the organotrihal osilane and hydridotrihalosilane (e.g. trichlorosilane and vinyl or phenyl trichlorosilane) to a mixture of catalyst, non-polar solvent, and polar solvent to form a reaction mixture. The polymerization reaction is allowed to proceed. Upon completion of the polymerization reaction, the reaction mixture is filtered, the polar solvent is separated, and the solution is dried and them evaporated to leave a white solid. This solid may then be slurried in hydrocarbon solvent to remove monomer, and finally evaporated to leave the desired product.

The Mw of the product produced can be varied between 400 and 200,000 AMU depending on the reaction conditions. We have found that materials with molecular weights of 10,000 AMU, 20,000 AMU, 40,000 AMU and 60,000 AMU all have good coating properties.

### EXAMPLES

The following examples describe the synthesis of various organohydridosiloxane compositions described herein and the various films, dielectric films, hardmask films and etch stop films contemplated herein. It should be understood that the organohydridosiloxane composition shown herein is one example of a polymer composition constituent and that other inorganic or organic polymers may be used as a constituent of the polymer composition that will ultimately liberate a radical precursor. Physical characteristics of the variously formed organohydridosiloxane compositions were compared to hydridosiloxane control samples having no organic content. The control hydridosiloxane samples were prepared according to the following method:

### Control

### Hydridosiloxane Polymer for Dielectric Constant Measurement

A 6 L jacketed reactor equipped with a nitrogen inlet, dry ice condenser and a mechanical stirrer is charged with 5500 ml hexanes 440 ml ethanol, 142 ml water and 330 g Amberjet 4200 catalyst. This mixture is equilibrated for 0.5 hr with stirring at 25° C. Trichloro silane (380 g, 2.80 mol) is added to the reactor using a peristaltic pump over a period of 55 minutes. Upon completion of the silane addition, hexane is pumped through the lines for 10 minutes. The reaction is stirred for 100 min, the ethanol/H2O layer is removed then the hexane solution is filtered through a 3-micron filter followed by a 1-micron filter. The filtered solution is dried by flowing through a column of 4 Å molecular sieves (400 g) for 2.5 h and then filtered through a 0.05 um filter. The hexanes are removed using a rotary evaporator to give a white solid product (131 g). Mw was measured by GPC as 21035 AMU with a polydispersity of 7.39.

Examples 1 and 2 describe the synthesis of HOSP polymer components, specifically vinyl-hydridosiloxane, and in particular, clearly illustrate how the percent carbon incorporated into the polymer composition may be controlled by adjusting the initial mole percent of organic-substituted monomer. By adjusting the ratio of the relative amounts of starting monomers, the mole percent of carbon-containing substituents in the polymer composition is controlled. It is understood by one skilled in the art that the same means for controlling percent carbon (adjusting the mole ratio of the monomer starting materials) may be used for other organohydridosiloxane species such as cycloalkyl-substituted organohydridosiloxanes, and aryl-substituted organohydridosiloxanes. Examples 3 and 4 describe the synthesis of LOSP polymer components. It should be understood that these syntheses (Examples 1-4) show the basic synthesis of HOSP and LOSP polymer compositions. The remaining Examples describe the formation and synthesis of polymer compositions that comprise HOSP and LOSP components and that also can liberate radical components or compositions, as discussed herein. These polymer compositions can be readily formed by the methods disclosed herein by using alkyl and aromatic trichlorosilane substitutes and varying the reaction time (as shown in Table 1).

### Example 1

### 50 Mole Percent Vinylhydridosiloxane

A 250 mL Morton flask was fitted with a condenser and a stirrer connected to an Arrow 1750 motor. The flask was purged with N₂ and during the reaction N₂ was blown across the top of the condenser into an NaOH scrubber. 18 g of Amberjet 4200 (Cl) ion exchange resin catalyst, 20 mL of ethanol, 6.3 mL of water, and 250 mL of hexanes were added to the flask, and stirring was started. Trichlorosilane (6.7 g, 0.05 Mol) and vinyltrichlorosilane (8.24 g, 0.05 mol) were combined together in all HDPE bottle. This mixture of silanes was added to the Morton flask through a peristaltic pump at a rate of 0.65 ml/min. After addition was completed, stirring was continued for 120 min., then the solution was allowed to settle for 30 min. The solution was filtered by vacuum through a Whatman #4 filter in a Buchner funnel. The solution was added to a separatory funnel and a lower, aqueous layer was discarded. The upper layer was dried over 40.23 g of 4 Å molecular sieves for 3 hr. Solution was filtered by vacuum through a Whatman #1 filter paper in a Buchner funnel. Solution was evaporated on a Buchi rotary evaporator at 60° C. 8.3 g of white solid was collected. The GPC of this product, referenced to polystyrene standards gave a Mw of 12,146 amu.

### Example 2

### 60 Mole Percent Vinylhydridosiloxane

A 6 L jacketed reactor equipped with a nitrogen inlet, dry ice condenser and a mechanical stirrer was charged with 5000 mL hexanes 720 mL ethanol, 50 mL water and 120 g of a 100% by weight tetrabutylammonium chloride hydrate solution in water. This mixture was equilibrated for 0.5 hr with stirring at 25° C. A mixture of trichlorosilane (251.6 g, 1.85 Mol) and vinyltrichlorosilane (416.5 g, 2.78 Mol) were added to the reactor using a peristaltic pump over a period of 70 minutes. Upon completion of the silane addition, hexane was pumped through the lines for 10 minutes. The reaction was stirred for 2. 8 hours, the ethanol/H₂O layer was removed using a separatory funnel. The remaining hexane solution was filtered through a 3 μm filter followed by a 1 μm filter. The filtrate was dried by flowing through a column of 4 Å molecular sieves (800 g) for 2.5 h and then filtered through a 0.05 μm filter. Hexanes were removed using a rotary evaporator to give 138 g of a white solid product. The GPC of this product, referenced to polystyrene standards gave a Mw of 22,660 with a polydispersity of 11.44.

### Example 3

### Preparation of 2 Mole Percent Vinylhydridosiloxane

A 2 L jacketed reactor was fitted with a condenser and a stirrer connected to an Arrow 850 motor. The flask was purged with N2 and during the reaction N2 was blown across the top of the condenser into an NaOH scrubber. 105.07 g of Amberjet 4200 (Cl) ion exchange resin catalyst, 140 mL of ethanol, 45 mL of water, and 1750 mL of hexanes were added to the flask, and stirring was started. 123 mL (1.219 mol.) of trichlorosilane and 3 mL (0.026 mol.) of vinyltrichlorosilane (2.1 mol % vinyltrichlorosilane) were combined together. This mixture of silanes was added to the Morton flask through a peristaltic pump at a rate oaf 3.2 mL/min. After addition was completed, stirring was continued fox 25 min. Solution was filtered by vacuum through a Whatman #4 filter in a Buchner funnel. Solution was added to a separatory funnel and the lower, aqueous layer was discarded. The upper layer was dried over 354.3 g of 4 A molecular sieves for 3 hr. Solution was filtered by vacuum through a Whatman #2 filter paper in a Buchner funnel. Solution was evaporated on a Buchi rotary evaporator at 60 C. 42.00 g of white solid was collected. Mw was measured by GPC as 21,312 AMU with a polydispersity of 4.80.

### Example 4

### Preparation of 20 Mole Percent Phenylhydridosiloxane

A 1 L jacketed reactor was fitted with a dry-ice condenser, a stirrer connected to an Arrow 850 motor, and a glass dip tube. Reactor was connected to a recirculating water bath set at 25 C. The flask was purged with N2 and during the reaction N2 was blown across the top of the condenser into an NaOH scrubber. 60.6 g of Amberjet 4200(Cl) ion exchange resin catalyst, 80 mL of ethanol, 25 mL of water, and 1000 mL of hexanes were added to the reactor, and stirring was started. 58 mL (0.575 mol.) of trichlorosilane and 19 mL (0.145 mol.) of phenyltrichlorosilane (20.1 mol % phenyltrichlorosilane) were combined together in an FEP bottle. This mixture of silanes was added to the reactor by peristaltic pump through a ¼″ Teflon tube at a set rate of 11.2 RPM. Calculated addition rate was 2.2 mL/min. After addition was completed, stilling was continued for 120 min. Solution was filtered by vacuum through a Whatman #4 filter in a Buchner funnel. Solution was added to a separatory funnel and the lower, aqueous layer was discarded. The upper layer was dried over 171 g of 4 Å molecular sieves for 3 hr. Solution was filtered by vacuum through a Teflon membrane with 1-micron pores set on a glass frit. Solution was evaporated on a Buchi rotary evaporator at 60 C. Yield was 31.0 g of white solid. Mw was measured by GPC as 23,987 AMU with a polydispersity of 10.27.

TABLE 1
HOSP AND LOSP-BASED POLYMER COMPOSITIONS THAT CAN
LIBERATE A RADICAL PRECURSOR/COMPONENT

| Substituted | Hours of | | | | | |
|---|---|---|---|---|---|---|
| trichlorosilane | Reaction | MW/hexanes | Yield (g) | Appearance | g/Moles | k |
| 10% phenylethyl | 22 | 57,738 | 116 | solid | 36.364 | 2.58 |
| 20% phenylethyl | 44 | 31,000 | 95 | sticky | 29.781 | 2.97 |
| 20% phenylethyl | 44 | 31,000 | 37 | sticky | 11.599 | 2.9 |
| 40% Me | | | | | | |
| 10% benzyl | 40 | 36,186 | 163 | solid | 51.097 | 2.54 |
| 30% benzyl | 44 | 23,855 | 162 | solid | 50.784 | 2.53 |
| 20% cyclohexyl | 21 | 25,119 | 111 | solid | 34.796 | 2.63 |
| 60% Me | | | | | | |
| 20% t-butyl | 114 | 23,000 | 61 | solid | 19.122 | 2.42 |
| 60% Me | | | | | | |
| 30% t-butyl | 15 | 29,752 | 24 | sticky | 56.21 | * |
| 33% Me | | | | | | |
| 40% t-butyl- | 117 | 11,663 | 107 | solid | 33.542 | 2.42 |
| HOSP 40% Me | | | | | | |
| 10% propyl | 18 | 23,053 | 140 | sticky | 43.887 | 2.55 |
| 20% propyl | 70 | 20,600 | 44 | sticky | 13.793 | 2.68 |
| 40% Me | | | | | | |
| 20% propylHSSO | 1 | 34,027 | 24 | sticky | 7.523 | [symbol] |
| 30% propyl | 17 | 24,779 | 82 | sticky | 25.705 | 2.59 |
| 40% Me | | | | | | |
| 40% propyl | 20 | 41,388 | 16 | sticky | 5.0157 | 2.55 |
| 20% Me | | | | | | |
| 40% propyl- | 94 | 25,020 | * | sticky | * | [symbol] |
| HOSP | | | | | | |
| 60% propyl- | 159 | 14,592 | 61 | sticky | 25.417 | 2.52 |
| HOSP | | | | | | |

### Example 5

LOSP-Based Experiments Showing Radical Precursor Liberation

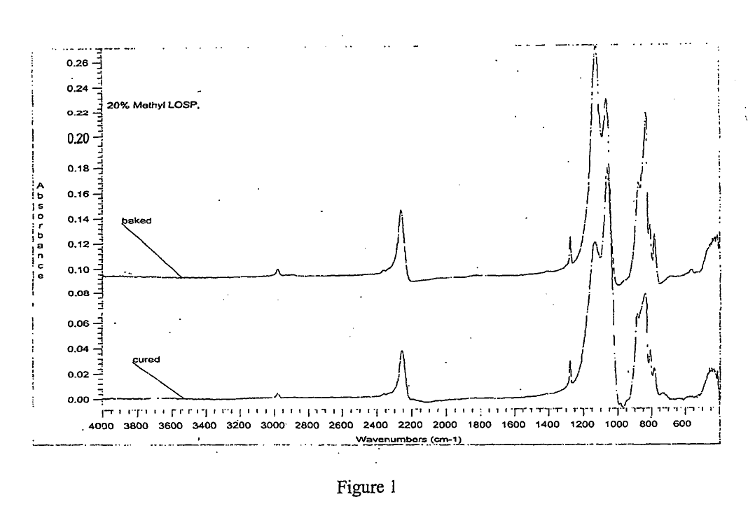

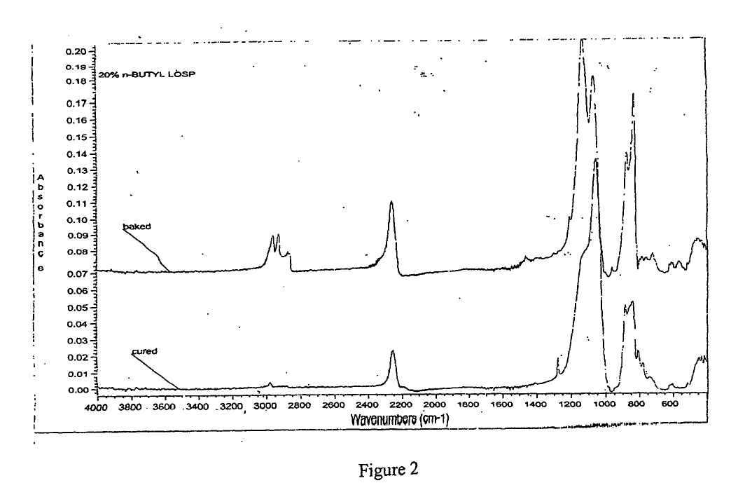

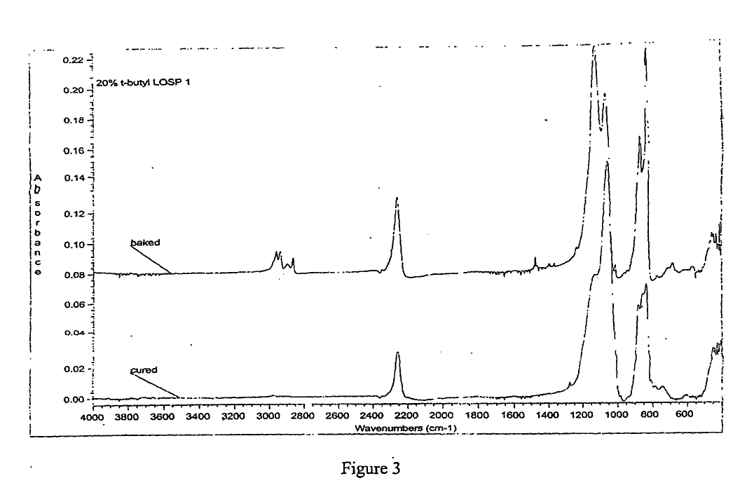

FIG. 1 shows infrared data collected for a standard LOSP polymer composition that comprises 200% methyl that was originally added in the form of methyltrichlorosilane. One set of infrared data represents the LOSP after the bake step and the other set of infrared data represents the LOSP after the cure step. FIGS. 2 and 3 show LOSP polymer compositions that comprise 20% n-butyl and 20% t-butyl respectively. Note that in both FIGS. 2 and 3 that the IR peak for n-butyl and t-butyl disappear after curing. In both instances, the n-butyl and t-butyl fragments began evolving (were liberated) at or above 400° C., as shown by MTM TDMS data collected. The dielectric constants measured were as follows: standard LOSP=2.9, 20% n-butyl=2.66, and 20% t-butyl=2.95. Another experiment using 10% t-butyl yielded similar IR data with a k=2.67.

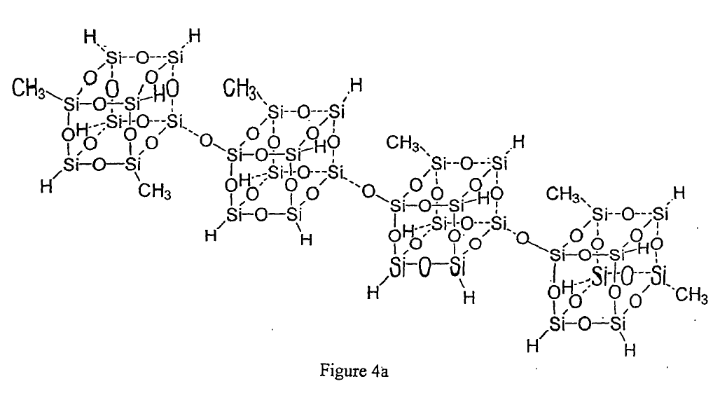

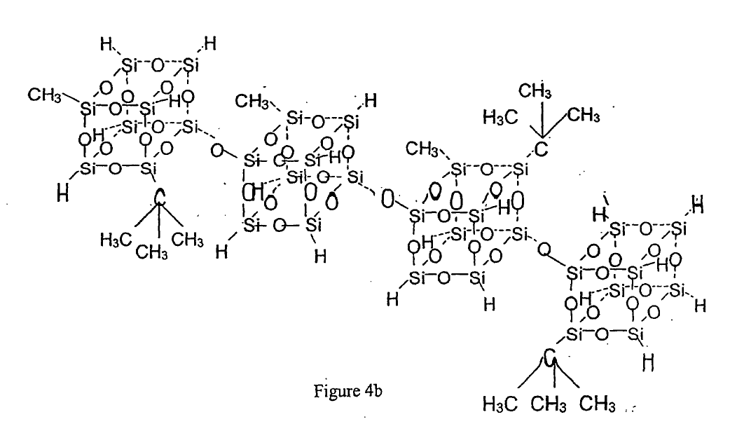

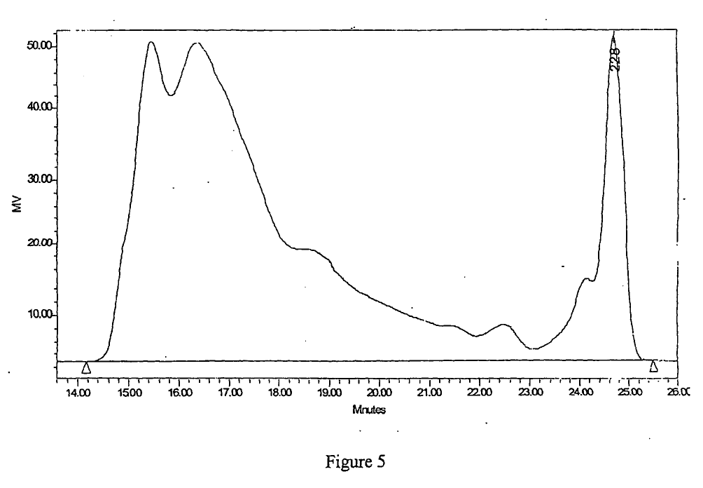

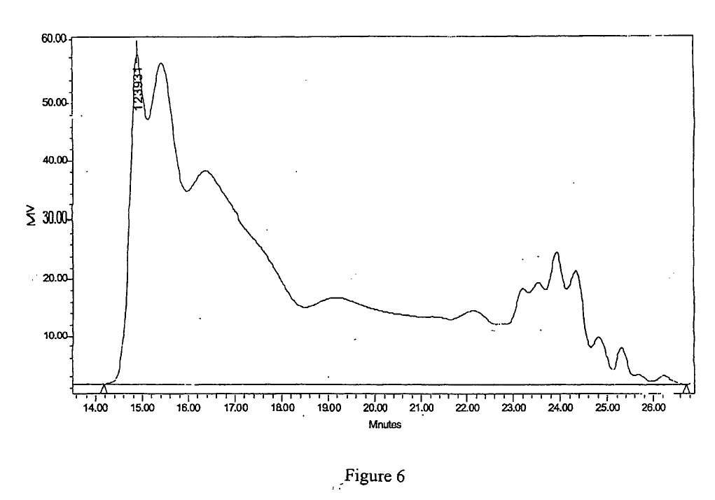

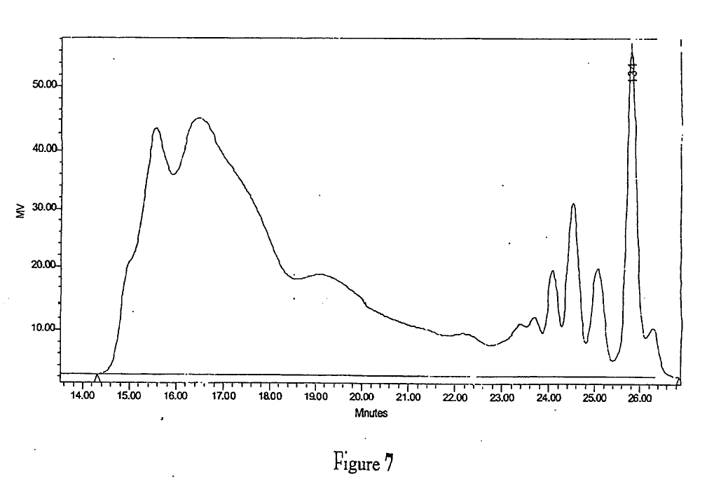

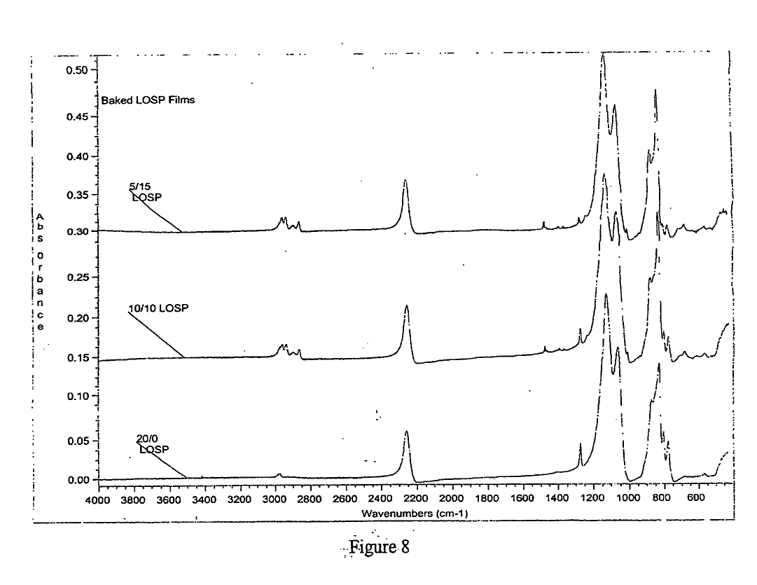

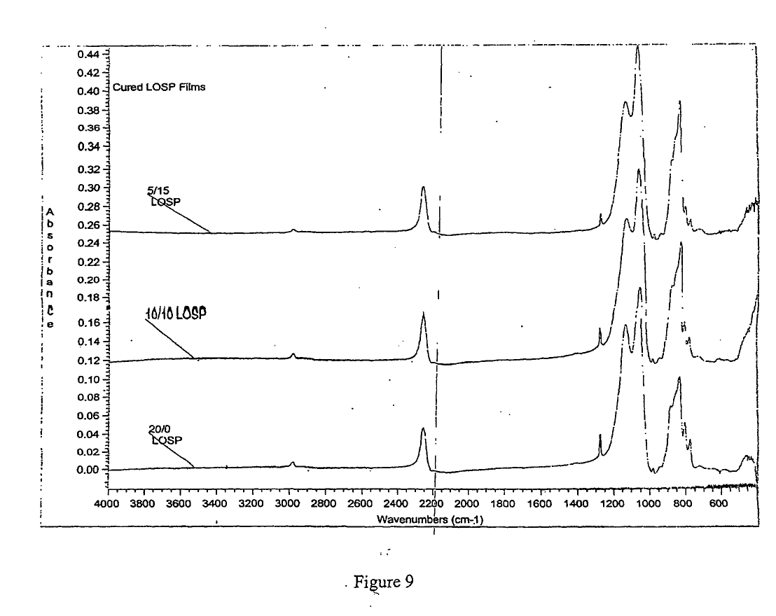

After the initial experiments on LOSP-based polymer compositions, other blends were developed, such as a) 10% Me, 10% t-butyl, 80% HSiCl₃ and b) 5% Me, 15% t-butyl, 80% HSiCl₃. FIGS. 4A and 4B show the standard LOSP structure and the methyl/butyl LOSP structure, for reference. In both the 10/10 blend and the 5/15 blend, the yield improved from 55% for standard LOSP to 68% for both the 10/10 and 5/15 blends. FIGS. 5-7 show the differences in the raw base polymer composition, as measured by GPC. FIG. 8 shows the IR data for the baked films of standard LOSP, the 10/10 blend and the 5/15 blend. FIG. 9 shows the IR data for the cured films of standard LOSP, the 10/10 blend and the 5/15 blend. The dielectric constants measured for the wafers cured at 400° C. are as follows: a) standard LOSP=2.76; b) 10/110 blend LOSP=2.69; and c) 5/15 blend LOSP=2.68. As far as the planarization measurements (the ability of the blend to planarize a surface with gaps), the data are as follows: a) standard LOSP gave 93% planarization on 1×1 μm lines and gaps and 89% planarization on 3×3 μm lines and gaps; b) the 1/10 blend LOSP gave 91% planarization on 1×1 μm lines and gaps and 83% planarization on 3×3 μm lines and gaps; c) the 5/15 blend LOSP gave 89% planarization on 1×1 μm lines and gaps and 79% planarization on 3×3 μm lines and gaps; and d) LOSP-T (5% Me) gave 90% planarization on 1×1 μm lines and gaps and 50% planarization on 3×3 μm lines and gaps. The cracking data for these wafers, observed after 24 hours at cleanroom ambient temperature, showed that a) standard LOSP has 1.03 μm cracks at the edge and 1.12 μm intermittent cracks across the wafer; b) the 10/10 blend LOSP has 1.08 μm massive cracking and 1.23 μm cracks after the bake; c) the 5/15 blend LOSP has 0.98 μm intermittent cracks across the wafer and 1.08 μm massive cracking. Finally, regarding basic spin properties, the following table shows those properties for standard LOSP, the 10/10 blend LOSP and the 5/15 blend LOSP:

TABLE 2

| | Material | | |
|---|---|---|---|
| | standard | | |
| | LOSP | 10/10 blend LOSP | 5/15 blend LOSP |
| Bake Thickness (Å) | 3909 | 4365 | 3971 |
| Bake Refractive | 1.4 | 1.399 | 1.407 |
| Index | | | |
| Cure Thickness (Å) | 4141 | 4175 | 3749 |
| Cure Refractive | 1.365 | 1.346 | 1.343 |
| Index | | | |
| Shrink (%) | −5.9 | 4.4 | 5.6 |

Thus, specific embodiments and applications of ultrananoporous materials and methods of formation thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A low dielectric material, comprising:
a polymer composition, wherein the polymer composition comprises at least one polymer component that further comprises at least one monomer component and wherein the at least one monomer component comprises a radical precursor chemically bonded to a structural precursor.

2. The low dielectric material of claim 1, wherein the radical precursor volatilizes during a cure process to form a plurality of ultrananopores and a gas.

3. The low dielectric material of claim 1, wherein the structural precursor forms a support material during a cure process.

4. The low dielectric material of claim 1, wherein the structural precursor comprises a siloxane compound.

5. The low dielectric material of claim 4, wherein the siloxane compound comprises an hydridosiloxane compound.

6. The low dielectric material of claim 4, wherein the siloxane compound comprises an organohydridosiloxane compound.

7. The low dielectric material of claim 1, wherein the structural precursor comprises an organic compound.

8. The low dielectric material of claim 7, wherein the organic compound comprises a poly(arylene) ether compound.

9. The low dielectric material of claim 7, wherein the organic compound comprises a cage molecule.

10. The low dielectric material of claim 9, wherein the cage molecule is an adamantane-based molecule.

11. The low dielectric material of claim 1, wherein the radical precursor comprises an alkyl group.

12. The low dielectric material of claim 11, wherein the alkyl group comprises at least one branched alkyl component.

13. The low dielectric material of claim 1, wherein the radical precursor comprises a cycloalkyl group.

14. The low dielectric material of claim 1, wherein the radical precursor comprises an aromatic group.

15. The low dielectric material of claim 1, wherein the radical precursor comprises at least one saturated bond.

16. A low dielectric film comprising the low dielectric material of claim 1.

17. An electronic component comprising the low dielectric material of claim 1.

18. An electronic component comprising the low dielectric film of claim 16.

19. A layered component comprising the low dielectric material of claim 1.

20. The low dielectric material of claim 1, wherein the material has a dielectric constant of less than about 3.

21. The low dielectric material of claim 20, wherein the material has a dielectric constant of less than about 2.5.

22. The low dielectric material of claim 21, wherein the material has a dielectric constant of less than about 2.

23. The low dielectric film of claim 16, wherein the film has a dielectric constant of less than about 3.

24. The low dielectric film of claim 23, wherein the film has a dielectric constant of less than about 2.5.

25. The low dielectric material of claim 25, wherein the film has a dielectric constant of less than about 2.

26. The low dielectric material of claim 2, wherein the plurality of ultrananopores comprises at least two voids.

27. The low dielectric material of claim 26, wherein each of the at least two voids comprises a mean diameter of less than about 10 nanometers.

28. A method of forming a low dielectric material, comprising:
providing a polymer composition, wherein the polymer composition comprises at lest one polymer component that further comprises at least one monomer component and wherein the at least one monomer component comprises a comprises a radical precursor chemically bonded to a structural precursor;
applying energy to the polymer composition, such that the radical precursor is volatilized; and
liberating at least in part the radical precursor from the polymer composition.

29. The method of claim 28, wherein forming the low dielectric material further comprises curing the polymer composition to form a support material and a plurality of pores.

30. The method of claim 29, wherein the plurality of pores comprise nanopores.

31. The method of claim 29, wherein the plurality of pores comprise ultrananopores.

32. The method of claim 28, wherein applying energy to the polymer composition comprises applying heat.

33. The method of claim 28, wherein the radical precursor comprises an alkyl group.

34. The method of claim 33, wherein the alkyl group comprises at least one branched alkyl component.

35. The method of claim 28, wherein the structural precursor comprises a siloxane compound.

36. The method of claim 35, wherein the siloxane compound comprises an hydridosiloxane compound.

37. The method of claim 35, wherein the siloxane compound comprises an organohydridosiloxane compound.

38. The method of claim 28, wherein the structural precursor comprises an organic compound.

39. The method of claim 38, wherein the organic compound comprises a poly(arylene) ether compound.

40. The method of claim 38, wherein the organic compound comprises a cage molecule.

41. The method of claim 40, wherein the cage molecule is an adamantane-based molecule.
